(19) United States
(12) Patent Application Publication
(10) Pub. No.: US 2006/0103172 A1
(43) Pub. Date: May 18, 2006

(54) Frame for a panel in a vehicle

(75) Inventors: Gerald R. Veen, Holland, MI (US); Brian D. Luurtsema, Byron Center, MI (US)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company

(21) Appl. No.: 11/274,807

(22) Filed: Nov. 15, 2005

Related U.S. Application Data
(60) Provisional application No. 60/629,182, filed on Nov. 18, 2004.

(51) Int. Cl. B60R 13/02

(52) U.S. Cl. 296/214

(57) ABSTRACT

An overhead system with an integrated structural, acoustic and mounting frame is provided for attachment to a roof panel in a vehicle. The system includes a headliner having a first side and a second side. A single rigid and acoustically absorbent pad is provided with a shape configured to interface with and couple to the first side of the headliner and an inside of the roof panel, so that the single pad provides structural support and acoustic absorption within an air gap between the headliner and the roof panel.

### CROSS REFERENCE TO RELATED APPLICATIONS

This Application claims the benefit of priority as available under 35 U.S.C. § 119(e) to U.S. Provisional Patent Application No. 60/629,182, titled “Frame for a Panel in a Vehicle” filed Nov. 18, 2004, which is incorporated herein by reference in its entirety.

### BACKGROUND

The present inventions relate generally to the field of frame members for use with panels for vehicles (e.g., automobiles such as cars, trucks, sport utility vehicles, recreation vehicles, and the like; airplanes, boats, etc.). More specifically, the present inventions relate to a frame member attached to a headliner panel to support the panel and to assist in retaining or supporting overhead system components coupled to the panel. More specifically, the present inventions relate to a frame member that provides structural rigidity and acoustic absorption to a panel for use in a vehicle, and may also provide structural rigidity to a steel roof portion of a vehicle body.

Headliner panels (“headliners”) for use in vehicle applications are generally known for providing an aesthetic covering for overhead structures and components within the vehicle interior. Such headliners are typically formed from relatively lightweight materials having sufficient structural rigidity (once formed into the headliner shape) to support their own weight. However, such known headliners tend to have certain disadvantages. For example, transport and installation activities tend to subject the headliner to stresses that may damage the headliner (e.g. tears, creases, cracks, deformation, etc.). Also, the known headliners typically require a wide variety of separate retainers for attaching the overhead system components to the headliner.

A recent trend to increase functionality in the overhead region of the vehicle has resulted in locating various components along a front surface (“A” surface) of the headliner for access by a user. These overhead system components are typically attached to the headliner (e.g. separately during manufacture of the vehicle, or as part of a preassembled overhead system shipped to vehicle manufacturers as a single unit for installation in a vehicle, etc.).

These overhead system components may include any of a wide variety of components including but not limited to consoles, grab handles, sun visors, lights, rail systems, instruments, storage compartments, media display devices, communication devices, side curtain airbag modules, etc. Such overhead system components typically require structural members (e.g. back brackets, retainers, fasteners, clips, plates, stiffeners, etc.) located on a back surface of the headliner to support the component on the headliner. The placement of the components on the headliners may also require that support be provided from the roof structure of the vehicle, or that the headliner is formed of more rigid (and typically heavier as well as higher cost) materials.

Other overhead system components that are usually “hidden” from an occupant of the vehicle may be supported by the headliner. Such “hidden” components are typically located along a back surface (“C” surface) of the headliner and may include any of a wide variety of components such as head-impact cushioning members, antennas, wires, wiring connectors and harnesses, ducts for heating, ventilation and air-conditioning, sound absorber pads, structural members to stiffen and dampen vibrations in a steel roof panel of a vehicle body, etc. Such “hidden” overhead system components also typically require a fastener (e.g. glue, brackets, tape, etc.) for securing the component to the C surface of the headliner. The placement of hidden components typically adds weight and stress to the headliner panel, often requiring additional reinforcing on the headliner.

Also, conventional overhead systems that include structural members and acoustic pads typically provide separate components to perform each function, where the pads typically overlay the C surface of the headliner and the structural members are fit through or around the acoustic pads for attachment to the headliner. The use of such individual components tends to increase the number of parts, assembly operation and overall complexity of manufacturing and installation of an overhead system in a vehicle.

Accordingly, it would be desirable to provide a frame for a panel for use in a vehicle having any one or more of these or other advantageous features:

1. A frame member that is lightweight and attachable to the C surface of the headliner.

2. A frame member that is contoured to adapt to the shape and contour of the headliner.

3. A frame member that increases the rigidity of the headliner without adding significant weight.

4. A frame member that is vacuum formed as a single piece and die-cut to a desired shape and size.

5. A frame member that is formed as a “skeleton” and provides structure only in areas where additional support is desirable

6. A frame member that is made of a recyclable plastic material.

7. A frame member that is shaped to provide a retainer structure for overhead system components attached to the headliner.

8. A frame member that is integrally formed with head-impact cushioning structure.

9. A frame member that is adaptable for use with existing headliner panels.

10. A frame member that is attachable to the headliner by a variety of methods such as hot-melt bonding, sonic weld, hot staking and hot-melt glue.

11. A frame member that is formed from a low cost material.

12. A frame member that provides structural support to the headliner and is adapted to replace a variety of conventional components typically provided on the headliner.

13. A frame member that is attachable to a headliner to support a variety of components for delivery to a vehicle manufacturer as a preassembled overhead system.

14. A frame member that is integrally formed with HVAC ducting.

15. A frame member that increases the rigidity of the overhead system so that the headliner substrate weight, stiffness and/or cost can be reduced.

16. A frame member that is integrally formed as the inside surface of an overhead storage compartment.

17. A frame member that is operable to replace conventional steel roof bows typically attached to a vehicle roof panel, that function to stiffen the roof panel and dampen vibrations in the roof panel.

18. A frame member that acts as a combined structural and acoustic absorption pad.

19. A frame member that is formed from a fibrous pad material to obtain an acoustically optimum flow resistance.

20. A combined structural and acoustic absorption pad contoured so that one side is attachable to the back of a headliner panel and an opposite side is attachable to a roof panel of the vehicle.

21. A combined structural and acoustic absorption pad having a panel portion located within an air gap (space) between the headliner and the roof panel to improve sound absorption performance.

### SUMMARY

One embodiment of the invention relates to a frame member for a panel in a vehicle, where the vehicle includes a headliner and a roof panel. The frame member includes a sheet of a material having a shape corresponding substantially with at least a portion of one surface of the headliner. Structural elements are integrally formed into the sheet to support components located on an opposite surface of the headliner.

Another embodiment of the invention relates to an overhead system for a vehicle. The system includes a headliner having a first side and a second side. A frame includes a molded sheet of rigid material with a contour corresponding to the first side of the headliner and coupled to the headliner. Structural elements are integrally formed into the frame and arranged to support components mounted on the second side of the headliner.

Another embodiment of the invention relates to a method of providing an overhead system for a vehicle. The method includes forming a headliner configured to fit the vehicle, forming a layer of a substantially rigid material into a sheet having a shape designed to overlay one side of the headliner and with structural elements arranged in a predetermined pattern, trimming the sheet to form a frame, and attaching the frame to the one side of the headliner.

Another embodiment of the invention relates to a overhead system having an integrated structural, acoustic and mounting frame for attachment to a roof panel in a vehicle. The system includes a headliner having a first side and a second side. A single rigid and acoustically absorbent pad is provided with a shape configured to interface with and couple to the first side of the headliner and an inside of the roof panel, so that the single pad provides structural support and acoustic absorption within an air gap between the headliner and the roof panel. The single pad may be molded to a predetermined thickness to provide an optimum air flow resistance for acoustic absorption.

### BRIEF DESCRIPTION OF THE DRAWINGS

FIG. 1 is a schematic representation of a perspective view of a frame member for a panel in a vehicle according to an embodiment.

FIG. 2 is a schematic representation of a perspective detail view of a portion of a frame member for a panel in a vehicle according to an embodiment.

FIG. 3 is a schematic representation of a cross sectional view of a portion of a frame member for a panel in a vehicle according to an embodiment.

FIG. 4 is a schematic representation of a top perspective view of a frame member having a structural and acoustic pad for use with a panel in a vehicle according to an embodiment.

FIG. 5 is a schematic representation of a cross sectional view of the structural and acoustic pad according to the embodiment shown in FIG. 4.

FIG. 6 is a schematic representation of a top perspective view of another frame member having a structural and acoustic pad for use with a panel in a vehicle according to an embodiment.

FIG. 7 is a schematic representation of a cross sectional view of the structural and acoustic pad according to the embodiment shown in FIG. 6.

### DETAILED DESCRIPTION

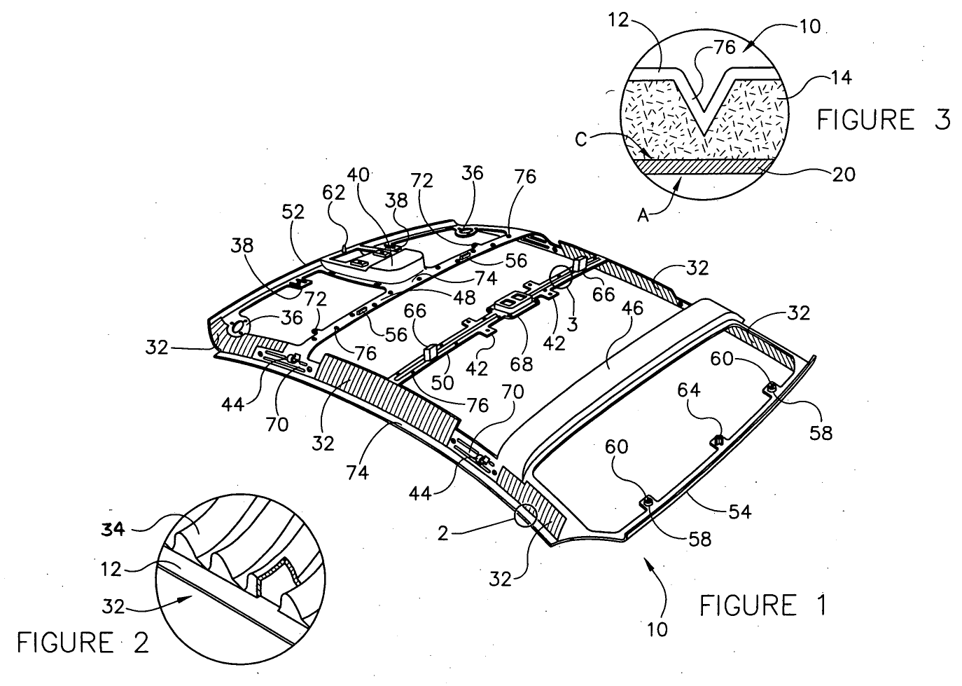

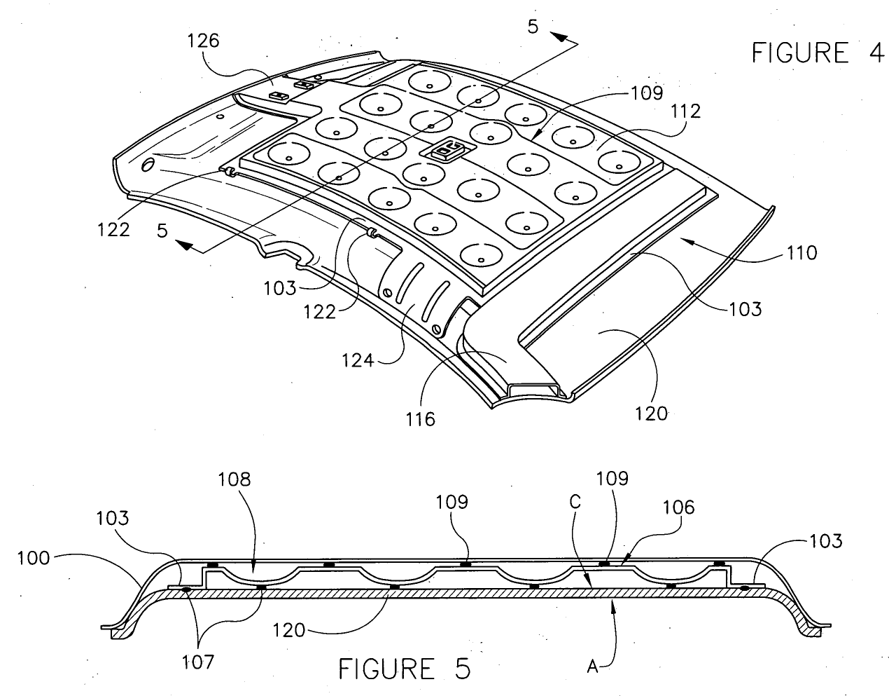

Referring to the FIGURES, an embodiment of a frame member (e.g. skeleton, support, stiffener, back-plate, etc.) is provided for use with a panel (e.g. headliner panel, perimeter trim panel, door panel, floor panel, etc.) for supporting the panel and providing a structure for retaining a wide variety of components attached to or associated with the panel within the interior (e.g. cabin) of a vehicle. The frame member is shown and described for use with a headliner panel. However, the frame member may be provided in other suitable shapes and forms for use with other panels within a vehicle. The frame member may be in the form of a skeletal overlay as shown in FIGS. 1-3 (with or without a separate acoustic absorption pad), and the frame member may be in the form of an integrated structural and acoustic pad that interconnects the headliner and the roof panel and has a substantial portion located within the air gap between the headliner and the roof panel as shown in FIGS. 4-7.

The frame member is intended to provide a lightweight, low cost structure that reduces cost and assembly time by adding structural support to certain desired locations of a headliner and providing a single structure configured to act as a “master-retainer” to replace the individual retainers, clips, brackets, etc. for any or all of the overhead system components to be attached to, or associated with, the headliner. The frame member may be configured for use with a separate sound absorption panel (e.g. acoustic pad) as shown in FIG. 1, or may be an integrated structural and acoustic pad as shown in FIGS. 4-7, where the acoustic absorption function is achieved by molding a fibrous pad to a particular thickness to obtain an optimum flow resistance.

According to one exemplary embodiment shown in FIGS. 1-3, a frame member for use with a panel in a vehicle is shown and described. A sheet of material is formed into a shape and contour corresponding to a surface of the panel. A plurality of structural elements are integrated into the sheet of material. The sheet of material is trimmed to provide a skeletal member having the structural elements arranged in a predetermined pattern corresponding to installation locations of the overhead system components and high-stress areas of the panel. The skeletal member is attached to the surface of the panel to provide structural support to the panel and pre-established locations for placement of the overhead system components on the panel. The panel may be a headliner panel for placement in an overhead portion of a vehicle. The sheet of material may be vacuum formed. The sheet of material may be die-cut or may be water-jet trimmed. The sheet of material may be plastic or may be a fibrous material (thermoplastic and/or natural fibers). The sheet of material includes recyclable materials. The structural elements of the skeletal member are (1) coextensive with at least a portion of the perimeter of the panel, (2) laterally span the width of the panel, and (3) at least partially surround an attachment location for at least one overhead system component. The structural elements include at least one of a back bracket, a retainer, a clip, a doghouse, an impact energy absorbing member, an acoustic absorbing member, and a connector. The skeletal member may be attached to the headliner by at least one of hot-plate melt, sonic weld, hot staking and hot glue. The skeletal member may also be attached to the headliner by “sandwiching” the headliner and the skeletal member between one or more overhead system components (e.g. grab handles, modules, visors, etc.) on the A surface and back brackets or other retainers on the opposite side. The overhead system components and the back brackets may be coupled together with the headliner and skeletal frame member therebetween by fasteners such as z-axis clips, screws, etc. The skeletal member with the structural elements may be attached to the panel and assembled with one or more of the overhead system components as a system and shipped as unit for installation with the vehicle.

According to another exemplary embodiment, a method of assembling an overhead system for a vehicle is also disclosed. The method includes the step of forming a headliner panel for a vehicle; forming a layer of rigid material configured to overlie a surface of the headliner panel and having a plurality of structural elements, trimming the layer of material to form a frame member having the plurality of structural elements arranged in a predetermined manner; attaching the frame member to the headliner panel in a close-fitting relationship; attaching at least one overhead system component to the headliner and supported by the frame member to provide a preassembled unit; shipping the preassembled unit to a vehicle manufacturer. The layer of rigid material may be plastic and formed by vacuum molding.

According to another exemplary embodiment shown in FIGS. 1-3, a structural frame member for a headliner is also disclosed. The frame member is vacuum formed from a layer of plastic material and includes a first structural element extending at least partially across an interior region of the headliner, and a second structural element extending at least partially around a perimeter of the headliner, and a third structural element providing a base for supporting at least one overhead system component that is attachable to the headliner. The overhead system component may be a rail member configured for coupling articles adjacent the headliner. The overhead system components may also comprise one or more of illumination devices, grab handles, coat hooks, visor mounting brackets, consoles, wires, tubes, ducts, antennae, electronic devices, side curtain air bags, overhead rail systems and components, communication devices, media display devices, instruments and impact energy or acoustic absorbing pads. The layer of plastic material may be trimmed to remove one or more non-structural portions to form a skeletal backing for the headliner.

Referring further to FIGS. 1-3, one embodiment of the frame member is shown as a relatively “thin” sheet 12 (e.g. layer, coating, backing, pad, etc.) made of a relatively rigid material configured for attachment to the C surface (i.e. the back surface oriented toward the roof panel) of the headliner 20. According to one embodiment, the sheet 12 of material is preferably a plastic material (such as ABS, PC-ABS blend, PET, etc.) that is shaped in a vacuum forming process to “mate” with or “overlie” the C surface of headliner 20 in a close-fitting or direct-contact relationship. According to other embodiments, the sheet 12 may be made from other materials such as fibrous materials (e.g. natural fiber, polymer fibers, polymer fiber blends such as EcoCore, recycled fibers, PET fibers, PolyPro fibers, polytrimethylene terephthalate (PTT), etc.), that are formed in a compression molding process or the like. According to alternative embodiments, the sheet of material may be formed by injection molding, twin sheet molding, or the like.

The sheet 12 of material is shown contoured to mate with the headliner 20 and to incorporate a wide variety of structural elements or features. For example, the sheet 12 of material may be integrally formed to include any one or more of the following structural elements or features.

One feature includes head-impact energy absorbers (“HIC”) 32, such as in the form of “wavy” plastic projections 34 (e.g. ribs, panels, or other suitable shapes) for absorbing energy upon impact.

Another feature includes retainers 36 for supporting or receiving brackets for mounting a visor adjacent to the A surface of the headliner 20 (e.g. “visor elbow brackets” etc.). Retainers 38 may also be provided for use with Euroclip brackets to mount visors adjacent to the A surface of the headliner panel 20.

The sheet 12 of material may also include a wide variety of other brackets or retainers. For example, retainers 40 or back-brackets may be provided for supporting overhead consoles (e.g. storage compartments, instruments, media devices, etc.) that are positioned against the A surface of the headliner panel 20. Also, retainers 42 or back brackets for supporting rail(s) (such as for a modular overhead storage system such as RailPort® or the like) may be routed along either the A or C surface of the headliner 20. In addition, channels or clips 44 may be included for routing and/or holding wires and wiring harnesses that are attached to or routed along a C surface of the headliner 20. Further, retainers 68 or back brackets may be provided to support illumination fixtures (e.g. map lamps, dome lamps, courtesy lamps, vanity lamps, conversation lamps, etc.). Additionally, retainers 70 or back brackets may be included for supporting other items such as grab handles, garment hooks, etc. Other retainers may include retainers 72 or back brackets for electronics or communication devices (e.g. speakers, microphones, plug-in jacks, etc.).

Another feature includes passages or ducts 46 for distribution of heating, ventilation or air conditioning (“HVAC”) within the cabin of the vehicle. For example, a three-sided passage may be formed and a fourth side may be added prior to (or after) attachment of the sheet to the headliner, or may be formed by the headliner itself.

Another feature includes vehicle roof structural components for applications where the headliner is intended to function as a “structural headliner.” The structural components may include crossbows 48, beams 50, headers 52, 54, bars, channels, etc. (individually or as a series of components) that may be used to replace or supplement conventional steel structural supports that typically provide support to the overhead structure of the vehicle.

Another feature includes compartments 56 for receiving fasteners used to mount components to the headliner. For example, a compartment may be formed for receiving Christmas-tree like connectors, z-axis clips, etc. in a hidden or concealed manner.

Another feature includes receiving structure for mounting fasteners (such as z-axis clips, push-pins, screws, Christmas-tree fasteners or the like) to the C surface of the headliner for attachment of the headliner to the vehicle. For example, it may be desirable to provide an attachment point between the headliner and the roof structure of the vehicle to prevent the headliner from sagging (e.g. due to weight or shape of the headliner, environmental conditions such as high humidity, etc.) or “flutter” (such as may occur due to road vibration), or to facilitate (temporarily or permanently) installation or “locating” the headliner in the proper position. Rather than extend a fastener from the A surface through the headliner for attachment to the roof structure, a receiving structure in the form of a “dog house” 58 or the like may be provided as a structural element on the sheet 12 of material. The dog house 58 may include a small “compartment” having a top surface (generally parallel to the headliner) with an opening such as a slot 60, so that a shank of a fastener (e.g. Christmas tree fastener, etc.) may be pressed into the slot 60 with the head of the fastener received in the compartment 58. The shank of the fastener is then attachable to the roof structure, while remaining hidden from the A surface of the headliner (i.e. a “blind” fastener). Mounting or “locator” bosses, projections or pins 62, 64 may also be provided to properly align or position the headliner 20 within the vehicle.

Another feature includes filler blocks 66 (e.g. “stand-off” blocks, etc.) configured to extend between the C surface of the headliner and the roof panel of the vehicle and intended to minimize deflection of the headliner panel 20 if force is applied on the A surface (e.g. hand pressure by a vehicle occupant, etc.). Another feature includes dual lock attachments for interconnecting hidden overhead components on the C surface of the headliner.

Another feature includes panel stiffeners 74 which are intended to be located along the headliner in high-stress areas that may be subject to undesirable deformation such as cracking, wrinkling, sagging, breaking, etc. The stiffeners may be provided laterally (as shown in FIG. 1) or longitudinally across the headliner panel, and may also be provided along the perimeter or peripheral edges of the headliner (as shown in FIG. 1).

Another feature includes support components for sun roof components (e.g. slides for a sunroof shade, etc.).

Another feature includes retainers 76 for acoustical absorber pads 14 intended to reduce noise intrusion into the vehicle cabin. Such retainers 76 may be shaped as brackets of the like configured to receive the pads in an interference or compression type fit, etc. (shown in FIG. 2 as a V-shaped ridge configured to compress or “pinch” the acoustic pad 14). The pads 14 may also be restrained by providing a gap or space between the sheet of material and the C surface of the headliner, within which the pad may be located by a compression or “snug” fit.

Another feature includes molded-in connectors, such as “snap” type connectors having a “living hinge” and “over center” type operation for attaching “hidden” components (e.g. wiring, acoustic absorbing pads, antennas, conduits or tubing for fluids such as rear window washers, etc).

The frame member 10 according to the exemplary embodiment is intended to provide a single structure that incorporates these and other features for structural support of the panel and attachment of overhead system components thereto. The integration of the various structural elements into a single structure is intended to minimize or reduce tooling costs and assembly/installation time, reduce parts and the logistics associated with providing such parts for assembly with the headliner. The integration of the structural elements into a single structure is also intended to improve quality of the headliner panel by providing for proper locating and placement of the various components on the headliner (e.g. error reduction, etc.). According to alternative embodiments, the frame member may be provided in two or more segments and interconnected into an assembly using conventional techniques.

Upon formation of the sheet 12 of material with the desired structural elements integrally formed therein for a particular headliner or overhead system application, the sheet of material may be “trimmed” to remove any exterior edge off-fall, overhang (or other extraneous portions) and any interior portions that are unnecessary (e.g. do not provide a desired structure or function, etc.). The sheet of material may be trimmed using any suitable method (such as die-cutting, water-jet cutting, laser cutting, etc.). The off-fall and interior portions removed from the sheet 12 of material are preferably “recycled” back into the process for formation of new sheets of material, such as may be formed by an extrusion process for use in the vacuum forming process.

The remaining “skeleton” formed by the trimming process provides a frame member 10 that is attachable to the C surface of the headliner 20 via any one of a variety of methods to provide a structural “backing” to the headliner 20. For example, the frame member 10 may be attached to the headliner 20 substrate by hot-plate melt method, sonic welds, hot staking, hot-melt glue, screws that are driven through components on the A or C surface of the headliner, or other suitable method. Attachment of the frame member 12 with its multitude of structural elements to the headliner 20 in a single operation is intended to replace the multitude of operations typically performed during assembly of an overhead system with the various separate and individual retainers typically required for the overhead components in conventional systems. The structural support for conventional overhead systems is typically provided by a headliner having sufficient thickness to support its own weight and the weight of all the system components. Because the frame member provides sufficient structural support to permit handling of the overhead system assembly without folding, cracking or other damage that might occur due to the weight of the overhead system, the weight and thickness of the headliner substrate can be reduced, which permits a lower cost substrate and helps to offset the weight of the frame member.

According to any preferred embodiment, the frame member 10 is made from a lightweight, generally rigid material, that is configured for attachment to a headliner to provide increased rigidity and protection to the headliner, and to support any of a wide variety of overhead system components attachable to, or associated with, either the A surface or the C surface of the headliner by consolidating various individual retainers, clips, brackets and fasteners, energy absorbers, etc. into a single frame member. The frame member is preferably vacuum formed and bonded or otherwise attached to the C surface of the headliner and may be formed with a “channel geometry” to provide increased stiffness. The tooling required for vacuum formation of the frame member, which may be physically “large,” is intended to be relatively low-cost compared to other methods, such as for example, injection molding. The frame member, although lightweight and “skeletal” in formation, is intended to provide substantial structural support by formation of suitable elements (channels, shapes, stiffeners, gussets, etc.). The size of the tooling may be reduced by forming the frame member in two or more segments for interconnection.

According to another exemplary embodiment shown in FIGS. 4-5 and 6-7, a frame member is formed from a fibrous blanket (mat, etc.) into a single pad that provides structural support, acoustic absorption, and integrated connection features for support of overhead system components. The pad has a shape and contour arranged to interconnect between the headliner and the roof panel of a vehicle using any suitable coupling technique, and to position a substantial portion of the pad within the air gap between the headliner and the roof panel to enhance acoustic performance. Combination of a structural panel, an acoustic pad and a framework for connection of overhead system components into a single pad is intended to reduce weight, cost, complexity and installation/assembly time of overhead systems in vehicles.

Referring further to FIGS. 4 and 5, a frame member 110 for use with a panel in a vehicle is shown according to another exemplary embodiment. Frame member 110 is shown to include a relatively thin and substantially rigid structural and acoustic pad 112 for use with a panel shown as a headliner 120. Pad 112 is contoured so that a first side 104 of the pad is attachable to the C surface of the headliner 120 and a second side 106 (opposite the first side 104) is attachable to an interior surface of a roof panel 100 in the vehicle. The contour of pad 112 is shown to interface with both the headliner 120 and the roof panel 100 so that the pad 112 is operable to support the headliner 120 from the roof panel 100 at a desired position. The contour of pad 112 is also configured to place a substantial portion of the pad at an intermediate position within the air gap (e.g. space, etc.) between the headliner and the roof panel. The applicants believe that placement of a sound absorbing pad within the air space (as opposed to directly against either the roof panel or the headliner) provides improved acoustic absorption performance. The weight and thickness of pad 112 are controlled during formation of the pad to obtain an optimum flow resistance range for acoustic absorption. According to one embodiment, the flow resistance range for acoustic absorption is within a range of approximately 800 to 3000 MKS Rayls when tested in accordance with ASTM C522. According to other embodiments, and suitable flow resistance range may be used for designing the weight and thickness of the pad. The applicants believe that when a relatively thin pad which has acoustically operative flow resistance is placed in an air cavity, a significant percentage of impending sound waves will be absorbed each time they pass through the pad. The resulting sound absorption benefit is believed to be generally equivalent to conventional thick absorber pads typically placed between a headliner and a rood panel in conventional vehicle applications.

The pad 112 is also constructed with sufficient structural properties to provide rigidity to the headliner 120 and avoid (or minimize) the need for separate roof structural elements such as crossbows, beams, etc. Pad 112 is also formed with sufficient acoustic absorption properties to improve the sound reduction within the vehicle interior. Accordingly, pad 112 is intended to combine the advantageous features of a structural panel and an acoustic blanket into a single pad that can be readily manufactured and installed within a vehicle and reduces the number of parts and assembly operations typically required with conventional headliners and overhead systems. The pad 112 may also be formed with a variety of additional structural elements for use in supporting other components of an overhead system (such as previously described with reference to frame member 10).

According to one exemplary embodiment, pad 112 is formed from a blanket made of fibers such as polymer fibers (e.g. polyester, polyester blend, polypropylene, PET, cotton fiber, polymer fiber blends, or other fiber material blends, etc.) and having a density within the range of approximately 100 to 600 grams per square meter (gsm) (although other suitable ranges or materials may be used according to other embodiments). Fibrous blankets suitable for this application include those commercially known as Decitex and available from INC of Sidney, Ohio and Formed Fiber Technologies, Inc. of Auburn, Me. One method of forming the pad involves a molding process which heats the fiber blanket (e.g. by convection or radiation, etc.) and then shapes the blanket into the desired contour by compression forming the fiber blanket in a cold tool to form the pad. The fiber blanket is molded to produce a pad 112 having a defined thickness, which produces a controlled airflow resistance through the pad that is optimized for acoustic absorption. According to one embodiment, a defined thickness is within the range of approximately 1 mm to 3 mm, however, other thickness ranges may be used to suit a particular application. An acoustic pad formed and positioned in such a manner is believed to have similar acoustic absorption properties as a “premium” sound absorber blanket, when placed within the airspace between the C surface of the headliner and roof panel. The pad formed from the fiber blanket according to the molding process is also relatively rigid (e.g. stiff, etc.) and is therefore useful as a roof structural support which can be adhered directly to the steel for stiffness, and is intended to be sufficiently effective for replacing conventionally installed separate structural components such as roof bows.

Referring to FIG. 4, pad 112 is shown formed with a contour that includes a plurality of shapes shown as for example as concavities 108 (but may be any suitable shape). The contour of pad 112 is intended to provide structure (shown as the “bottom” of the concavities or along perimeter flanges 103) on side 104 adjacent to the C surface of the headliner 120 that interface with the headliner for attachment thereto, such as at points 107 by any suitable coupling method (e.g. hot melt adhesive, sonic welding, heat staking, etc.). The pad 112 also has a top surface 106 formed at a height above the bottom of concavities 108, which is shaped in a manner intended to “follow” and interface with the inner surface of the roof panel 100 for attachment of the pad thereto such as generally along lines 109 (e.g. by hot melt adhesive, sonic welding, heat staking, etc.). Attachment 109 may occur separately from attachment 107 (e.g. when an overhead system assembly including the headliner, components and pad are shipped as a unit to a manufacturing facility for installation into a vehicle. The remaining portion of the pad 112 is located at a generally intermediate position between the headliner 120 and the roof panel 100 to provide improved sound reduction performance. Placement of the portion of pad 112 in the air gap or space between the headliner and the roof panel is intended to take advantage of sound wave reflection between the surfaces of the pad and the surfaces of the headliner and the roof panel in a manner that the applicants believe enhances sound reduction performance.

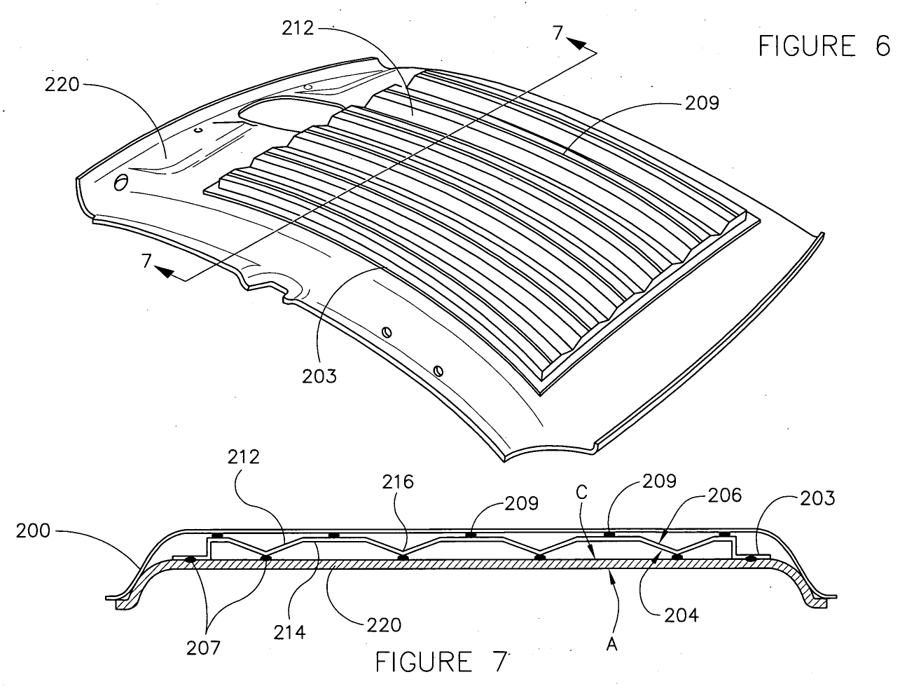

The structural and acoustic pad may be formed in any of a wide variety of shapes and contours that generally follow the shape of the roof panel and the headliner, and that position a substantial portion of the pad at an intermediate portion of the air gap between the headliner and roof panel. For example, FIGS. 6-7 illustrate one of many another embodiments of the shape of a pad 212 with a top surface 206 and a bottom surface 204 where the concavities have been replaced by a series of ridges 214 and valleys 216 for interconnection between a roof panel 200 and a headliner 220 by coupling with, for example, adhesive bonding at locations 207 and 209. Accordingly, the pad may have any desirable shape that interfaces with the roof panel and the headliner and locates a substantial portion of the pad within the air gap between the headliner and the roof panel to enhance acoustic performance. The shape of the pad may also be designed to improve or enhance the stiffness of the pad (e.g. with ribs, beams, gussets, etc.), so that interconnection of the pad with the roof panel and the headliner provides a desired degree of structural strength and stability for the overhead portion of a particular vehicle. The pad may also be formed with such stiffening shapes in proximity with connecting points for supporting components of an overhead system.

Formation of the pad into a shape having a sufficient height to interface between the headliner and roof panel is also intended to reduce or eliminate the need for conventional spacers, such as foam blocks, cardboard liners, etc. that are typically used to support the headliner from the roof panel (or from structural elements of the roof panel). In addition, use of a single structural and acoustic pad is intended to reduce the cost of a typical overhead system by enabling use of a lighter weight headliner substrate (e.g. 800 gsm as opposed to 1000 gsm) and can also eliminate stiffeners, further reducing parts, cost and weight.

Referring further to the embodiment shown in FIG. 4, pad 112 can be used as an HVAC passage 116 such as an air duct or air cap, which may be molded into the shaped pad in the appropriate areas. The portion of the pad that forms the HVAC passage 116 may be coated with a suitable material to reduce air permeability of the pad along the passage. According to another embodiment, the material of the pad at the location of passage 116 may be compression molded to a much lower thickness (i.e. greater compression), to increase resistance to air flow (e.g. impermeability, etc.) in that area. According to embodiments in which the passages are air caps provided along areas at are near the perimeter of the pad, then a 360° air duct can be created by molding both sides of the duct into the pad (e.g. as 180° air caps), and then thermo-folding one side under the other side (e.g. on a living hinge) and adhesively adhering the cut edge to the other side of the pad (e.g. in a “mold and fold” manner) to form a 360° air duct.

Referring further to FIGS. 4-5, the pad 112 may also be formed with additional features to act as an integrated carrier for other components associated with the headliner or an overhead system. For example, clips or retainers 122 for wire or wire harness routing may be formed into the pad to manage (e.g. hold, route, etc.) overhead system wires and harnesses. Also, the pad 102 may be molded and positioned so that it functions as a back-bracket on the C surface of the headliner to support elements of the overhead system that are connected on the A surface of the headliner. Other component retainers 124, such as for use with grab handles, or retainers 126 for use with overhead consoles, etc., may be formed into the pad to reduce or eliminate conventional injection molded plastic parts, which reduces weight and cost.

The improved structural and acoustic performance of the headliner with the frame member or pad attached thereto as shown in the illustrated embodiments is also intended to provide a more aesthetically pleasing appearance to the A surface of the headliner by minimizing the tendency for sagging, wrinkling and other defects on the headliner. Manufacturing scrap/rework and warranty-related expenses for headliners and overhead systems are also expected to be reduced due to the additional structural support and integration of preformed and pre-positioned structural support elements on the headliner.

The construction and arrangement of the elements of the frame member and pad for a panel for a vehicle as shown in the various embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes, contours and proportions of the various elements, methods of formation, methods of trimming, values of parameters, mounting arrangements, use of materials, colors, orientations, etc.) without materially departing from the novel teachings and advantages of the subject matter recited herein (e.g., the frame member or pad may be formed from any suitable material and trimmed to any suitable shape, contour, thickness, air permeability and configuration to support the headliner and components to be attached to, or associated with, the headliner. For example, the acoustic and structural pad may have any desirable shape and contour to provide a single component having a desired stiffness for overhead support, and having a desired air flow permeability for acoustic performance, and molded-in attachment elements for connecting overhead system components. Also, elements shown as integrally formed may be constructed of multiple parts or elements (e.g., the frame member and pad may be formed from various materials in a homogenous or composite manner), the position of elements may be reversed or otherwise varied (e.g., the acoustic pads for use with the frame member may be formed within or integrally with the headliner), and the nature or number of discrete elements or positions may be altered or varied (e.g., the frame member and pad may be large for covering an entire headliner, or the frame member may be smaller and intended to cover only a portion of the headliner (for use in custom applications or for use in unique spaces). It should be noted that the elements and/or assemblies of the frame member may be constructed from any of a wide variety of materials and in any of a wide variety of colors, textures and combinations. Other substitutions, modifications, changes and omissions may be made in the design, operating conditions and arrangement of the various embodiments without departing from the scope of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the claims provided in any future patent applications that claim priority to this Application.

What is claimed is:

1. A frame member for a panel in a vehicle, the vehicle including a headliner and a roof panel, the frame member comprising:
a sheet of a material having a shape corresponding substantially with at least a portion of one surface of the headliner;
a plurality of structural elements integrally formed into the sheet and configured to support a plurality of components disposed on an opposite surface of the headliner.

2. The frame member of claim 1 wherein the sheet of material is trimmed to provide a skeletal form.

3. The frame member of claim 2 wherein skeletal form is configured to attach to a C surface of the headliner.

4. The frame member of claim 1 wherein the sheet of material is vacuum formed and trimmed by one of a die-cut process and a water-jet process.

5. The frame member of claim 1 wherein the structural elements are configured to be at least partially coextensive with a perimeter of the headliner.

6. The frame member of claim 1 wherein the structural elements are arranged in a layout configured to correspond with the plurality of components mounted on an A surface of the headliner.

7. The frame member of claim 1 wherein the structural elements comprise at least one of a back bracket, a retainer clip, a doghouse, a side curtain airbag module, and an impact absorbing member.

8. An overhead system for a vehicle, comprising:
a headliner having a first side and a second side;
a frame including a molded sheet of rigid material having a contour corresponding to at least a portion of the first side of the headliner and coupled thereto;
a plurality of structural elements integrally formed into the frame and arranged to support a plurality of components mounted on the second side of the headliner.

9. The overhead system of claim 8 wherein the sheet of material includes a plurality of cutouts.

10. The overhead system of claim 9 further comprising an acoustic pad disposed between the first side of the headliner and the molded sheet of rigid material.

11. The overhead system of claim 8 further comprising an air duct integrally formed into the molded sheet of rigid material.

12. The overhead system of claim 8 wherein the plurality of components are secured to the headliner and the molded sheet of rigid material by fasteners that engage the structural elements.

13. The overhead system of claim 12 wherein the headliner and the components and the molded sheet of rigid material are configured for shipment as a unit for installation in a vehicle as a complete assembly.

14. A method of providing an overhead system for a vehicle, comprising:
forming a headliner configured to fit the vehicle;
forming a layer of a substantially rigid material into a sheet having a shape designed to overlay one side of the headliner and with a plurality of structural elements arranged in a predetermined pattern;
trimming the sheet to form a frame; and
attaching the frame to the one side of the headliner.

15. The method of claim 14 further comprising the step of mounting at least one component to another side of the headliner and attaching the component to one of the structural elements to provide a preassembled unit.

16. The method of claim 15 further comprising the step of shipping the preassembled unit to a facility for installation in a vehicle.

17. The method of claim 15 further comprising the step of routing wires along the one side of the headliner to the component and securing the wires with another one of the structural elements.

18. The method of claim 15 further comprising the step of positioning an acoustic pad between the headliner and the sheet.

19. The method of claim 15 wherein at least one of the structural elements is configured to couple the headliner to a roof structure of the vehicle.

20. An overhead system having an integrated structural, acoustic and mounting frame for attachment to a roof panel in a vehicle, comprising:
a headliner having a first side and a second side;
a single substantially rigid and acoustically absorbent pad having a shape configured to interface with and couple to the first side of the headliner and an inside of the roof panel;
so that the single pad provides structural support and acoustic absorption within an air gap between the headliner and the roof panel.

21. The overhead system of claim 20 wherein the single pad further comprises a plurality of structural elements integrally formed therein and configured to support one or more components mountable on the second side of the headliner.

22. The overhead system of claim 20 wherein the single pad comprises a compressed fibrous blanket configured to follow the headliner and the roof panel.

23. The overhead system of claim 22 wherein the single pad includes a first portion coupled to the first-side of the headliner.

24. The overhead system of claim 23 wherein the single pad further includes a second portion configured to couple to the roof panel,

25. The overhead system of claim 24 wherein the single pad comprises a contour to position a third portion at an intermediate location within a space between the headliner and the roof panel.

26. The overhead system of claim 25 wherein the contour comprises a plurality of concave elements.

27. The overhead system of claim 25 wherein the contour comprises a plurality of ridges and valleys.

28. The overhead system of claim 25 wherein the single pad further comprises structural elements integrally formed with the pad and located to support one or more components disposed on the second side of the headliner.

29. The overhead system of claim 28 wherein the single pad further comprises an air passage integrally formed therein.

30. The overhead system of claim 29 wherein a portion of the pad that forms the air passage is compressed to a thickness that is less than a thickness of a non air passage portion of the pad.
